(19) United States
(12) Patent Application Publication
(10) Pub. No.: US 2022/0405807 A1
(43) Pub. Date: Dec. 22, 2022

(54) INFORMATION PROCESSOR AND STORAGE MEDIUM

(71) Applicant: SiGNITY, Inc., Tokyo (JP)

(72) Inventors: Shun KASAHARA, Tokyo (JP); Kyoichi KAWAMOTO, Tokyo (JP); Shingo IMOTA, Tokyo (JP)

(21) Appl. No.: 17/841,337

(22) Filed: Jun. 15, 2022

(30) Foreign Application Priority Data
Jun. 17, 2021 (JP) 2021-101109

(51) Int. Cl. G06Q 30/02; H04L 67/55; H04L 67/50

(52) U.S. Cl. CPC G06Q 30/0269; G06Q 30/0277; H04L 67/55; H04L 67/535

(57) ABSTRACT

A non-transitory storage medium stores a program causing a computer to implement a process. The computer is a user terminal connected via a network to a first server that distributes contents and a second server that transmits a push notification. The process includes: generating key information that defines validity of distribution reception of the contents to a first server in response to an access to a web page of a site where the first server distributes the contents; storing the generated key information in a storage unit; receiving a push notification from a second server; detecting an operation for linking to an advertisement page from the push notification; and updating the key information on the basis of the detection of the operation.

### FIELD

Embodiments described herein relate generally to an information processor and a storage medium.

### BACKGROUND

At present, a large number of distribution sites for distributing contents such as comics, music, movies, and videos are available on the Internet. Such distribution sites include a distribution site where all users who visit the site are provided with free access to contents, a distribution site where all registered users are provided with free access to contents on condition that necessary information including a name and an email address is registered (user registration), and a distribution site where access is limited only to paying users.

In a distribution site where charging is included in the terms of use, a fee can be directly collected from a user for each access to contents. However, users still have inhibitions in paying for contents, and it is difficult to collect chargeable contents attractive to users and acquire users who regularly access the contents. In a distribution site where the terms of use are not provided or only user registration is necessary, charging is not included in the terms of use and thus users who regularly access contents are easily acquired. However, a fee cannot be directly collected from a user.

The operating companies of distribution sites have posted, for example, advertisements from sponsors in the distribution sites in order to obtain advertising income via the distribution sites. As a method for posting an advertisement in a distribution site, a method of inserting a video advertisement in a watched video and a method of displaying a banner advertisement on a distribution page are known. Although video advertisements are expected to be viewed by users, users may feel annoyed by video advertisements that interrupt viewing of videos. Banner advertisements are not so annoying as video advertisements, but active viewing from users cannot be expected.

### SUMMARY OF THE INVENTION

### Technical Problem

An object of the present invention is to motivate users to view advertisements.

### SOLUTION TO PROBLEM

A non-transitory storage medium storing a program causing a computer to implement:

generating key information that defines validity of distribution reception of contents to a first server in response to an access to a web page of a site where the first server distributes the contents; the computer is a user terminal connected via a network to a first server that distributes contents and a second server that transmits the push notification

storing the generated key information in a storage unit;

receiving a push notification from a second server;

detecting an operation for linking to an advertisement page from the push notification; and

updating the key information on the basis of the detection of the operation.

### BRIEF DESCRIPTION OF THE VIEWS OF THE DRAWING

FIG. 1 illustrates the configuration of an advertisement distribution system according to a first embodiment;

FIG. 2 is a block diagram illustrating an advertisement distribution management server in FIG. 1;

FIG. 3 illustrates an example of a terminal information management table stored in a storage device in FIG. 2;

FIG. 4 illustrates an example of a site information management table stored in the storage device in FIG. 2;

FIG. 5 illustrates an example of an advertisement information management table stored in the storage device in FIG. 2;

FIG. 6 is a flowchart showing an example of steps up to the registration of a cryptographic key in a user terminal that is a visitor of the top page of a music site;

FIG. 7 illustrates an example of a reception screen in FIG. 6;

FIG. 8 is a flowchart showing an example of steps from the transmission of a push notification to the user terminal to the update of the cryptographic key registered in the user terminal;

FIG. 9 illustrates an example of the notification screen of a push notification in FIG. 8;

FIG. 10 is a flowchart showing an example of steps from the access of the user terminal to limited contents with an invalid cryptographic key to the update of the cryptographic key;

FIG. 11 illustrates an example of a response screen in FIG. 10;

FIG. 12 is a flowchart showing another example of steps up to the registration of a cryptographic key in the user terminal that is a visitor of the top page of the music site;

FIG. 13 is a flowchart showing another example of steps from the transmission of a push notification to the user terminal to the update of the cryptographic key registered in the user terminal; and

FIG. 14 is a flowchart showing another example of steps from the access of the user terminal to limited contents with an invalid cryptographic key to the update of the cryptographic key.

### DETAILED DESCRIPTION

A first embodiment and a second embodiment of the present invention will be described below with reference to the accompanying drawings.

A feature of the present invention is to store, a user terminal, information (key information) for determining validity for receiving the distribution of contents (limited contents) from a server and to determine, at the user terminal, the validity for receiving the distribution of contents on the basis of key information. Another feature is to detect, at the user terminal, a click made on the URL of an advertisement page to link to the advertisement page from a push notification transmitted to the user terminal, update the key information, and extend a validity period for receiving the distribution of contents. The management of validity for receiving the distribution of contents is completed at the user terminal.

In the first embodiment and the second embodiment, a music site where limited contents such as music and music videos are distributed to user terminals by streaming will be described as an example. A user terminal for a user who has made the first access to the music site is provided with cryptographic key information for using contents restricted (limited contents) in the music site. The cryptographic key information includes a cryptographic key and a validity period. The user can use the limited contents of the music site any number of times in the validity period. After the validity period, the cryptographic key becomes invalid, so that the user cannot use the limited contents of the music site. To enable the invalidated cryptographic key again or as an opportunity for extending the validity period of a valid cryptographic key, a push notification is transmitted to the user terminal from the music site. The push notification describes, for example, a link to the URL of an advertising web page. In response to a click on the URL to link to the advertising web page, the invalidated cryptographic key is enabled again or the validity period of a valid cryptographic key is extended in the specifications. By extending the access period of limited contents in the music site or restarting access to limited contents, users are highly motivated to click the screen of a push notification. Thus, active viewing of the advertising web page by users can be expected.

If access to limited contents can be limited, the number of valid accesses or valid points may be determined for the cryptographic key instead of the validity period. For example, 100 points are determined as valid points, and valid points are consumed each time user access to a limited content such as music, music video or the like is performed. Users can access the limited contents until the valid points are completely consumed.

The cryptographic key information may be managed and updated by a user terminal, a server that manages limited contents, or other external servers. Likewise, whether limited contents are accessible to users may be determined by a user terminal, a server that manages limited contents, or other external servers.

### First Embodiment

An advertisement distribution system according to a first embodiment is configured such that a user terminal manages cryptographic key information, updates the cryptographic key information, and determines whether limited contents are accessible to a user on the basis of the cryptographic key information.

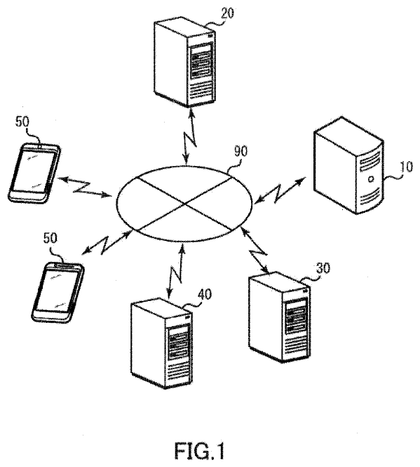

As illustrated in FIG. 1, the advertisement distribution system includes an information processor (advertisement distribution management server) 10 managed by a company (advertisement distributor) that provides advertisement distribution management service, an information processor (content distribution server, first server) 20 that is managed by the operating company of a music site and is provided for distributing music contents, an information processor (advertisement distribution server) 30 for distributing an advertisement page, and an information processor (push-notification distribution server, second server) 40 that transmits a push notification to a user terminal 50. The processors and terminals are connected so as to communicate with one another via a network 90 such as the Internet, e.g., the Internet. The user terminals 50 are connected to the servers constituting the advertisement distribution system such that the user terminals 50 can communicate with the servers via the network 90.

The content distribution server 20 stores data on a plurality of HTML files of respective web pages constituting a music site and data on music contents to be distributed. In response to a content distribution request from the browser of the user terminal 50, the content distribution server 20 transmits data corresponding to requested contents to the browser of the user terminal 50. In any stored web page of the music site in the content distribution server 20, typically an HTML file corresponding to the top page, two HTML tags are embedded. The first HTML tag is a tag for requesting a reception program, which will be described later, from the advertisement distribution management server 10. The second HTML tag is a tag for requesting a registration program, which will be described later, from the advertisement distribution management server 10.

If the user terminal 50 having accessed the top page of the music site can execute the reception program and the registration program, an embodiment for implementing the execution of the programs is not limited to the foregoing embodiment. For example, the two programs may be directly described on the top page of the music site or the two programs may be requested from a server other than the advertisement distribution management server 10.

The content distribution server 20 has the function of authenticating the user terminal 50 having requested the distribution of limited contents. For example, when information indicating the accessibility of limited contents is received from a service worker registered for the browser of the user terminal 50, the content distribution server 20 transmits data on requested limited contents to the user terminal 50. When information indicating the inaccessibility of limited contents is received or when information indicating the accessibility of limited contents is not received, the content distribution server 20 transmits, to the user terminal 50, data on a notification screen for notifying the inaccessibility of the limited contents to a user.

The advertisement distribution server 30 stores data on an HTML file corresponding to an advertisement page and contents data constituting the advertisement page. When receiving a distribution request of an advertisement page from the browser of the user terminal 50, the advertisement distribution server 30 transmits data on an HTML file for the requested advertisement page to the browser of the user terminal 50.

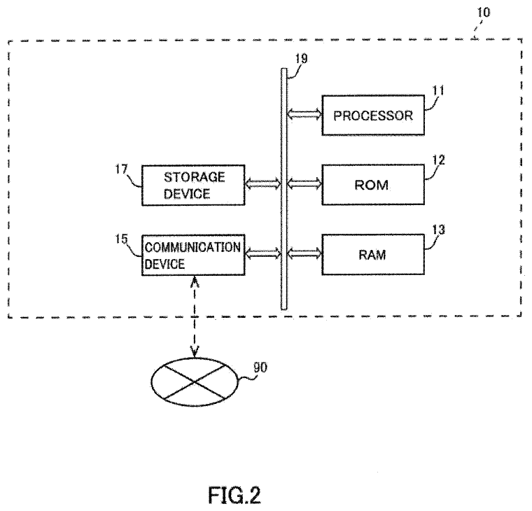

As illustrated in FIG. 2, the advertisement distribution management server 10 includes a processor 11. The processor 11 includes a central processing unit (CPU) and a graphics processing unit (GPU) and exercises centralized control over the devices connected to a system bus 19 and a controller. In a ROM 12, for example, a basic input output system (BIOS) to be executed by the processor and an operating system (OS) program are stored. A RAM 13 acts as the main memory of the processor 11 and a work area or the like. In a storage device 17, various programs and table data or the like are stored. The detail will be described later. A communication device 15 controls communications with an external device via the Internet.

In the storage device 17, the reception program and the registration program are stored.

The reception program is a program describing a series of processing for receiving whether to receive a push notification from the music site and registering, in the push-notification distribution server 40 and the advertisement distribution management server 10, terminal information on the user terminal 50 that permits the reception of the push notification. The reception program is executed by the browser of the user terminal 50, thereby implementing the function of displaying a permission screen of a push notification from the music site on the screen of the user terminal 50, the function of transmitting a registration request for the push notification to the push-notification distribution server 40 when a permission button on the permission screen is pressed in response to an operation of the user terminal 50, and the function of transmitting the permission notification of the push notification to the advertisement distribution management server 10.

The registration program is a simple program such as JavaScript for installing a service worker on the user terminal 50 via the browser and is incorporated with specific tabs in the web page. The service worker is JavaScript describing a series of processing of the management of the cryptographic key information, an update of the cryptographic key information, and determination based on the cryptographic key information in the music site and operates in the background of the browser. The service worker is prepared for each site using a cryptographic key and is managed by information that identifies a site using the cryptographic key. The service worker is executed at the user terminal 50, thereby implementing the function of storing, in the storage area of the browser, the cryptographic key information for using the music site, the function of detecting an operation for linking to an advertisement page from the notification screen of a push notification (a click on the URL of the advertisement page) and updating the cryptographic key information, the function of, when transmitting a content distribution request to the content distribution server 20 from the user terminal 50, referring to the cryptographic key information to determine the validity of the reception of a distribution request for limited contents by a user, and the function of enabling/disabling the transmission of the distribution request for limited contents to the content distribution server 20 according to the determination result.

The storage device 17 stores a table for managing terminal information about the user terminal 50 where the reception of a push notification is permitted (terminal information management table), a table for managing site information about the application of advertisement distribution service, in other words, the provision of the reception program and the registration program (site information management table), and a table for managing advertisement information posted from an advertiser (advertisement information management table).

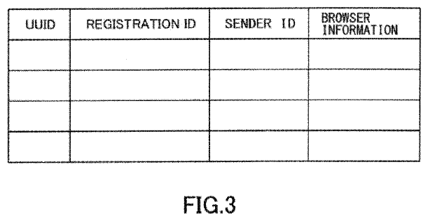

As illustrated in FIG. 3, in the terminal information management table, various kinds of information for specifying a destination of a push notification are stored. For example, terminal information is associated with a universally unique identifier (UUID) for uniquely identifying the user terminal 50 that has permitted a push notification. The terminal information is transmitted from the user terminal 50 and includes a registration ID, a sender ID, and browser information. The registration ID is a unique ID for identifying the user terminal 50 that has permitted the reception of a push notification. The registration ID is issued by the push-notification distribution server 40. The sender ID is a unique ID for identifying the sender of a push notification. The sender ID is issued by the push-notification distribution server 40. The sender ID is issued for each application or each web site.

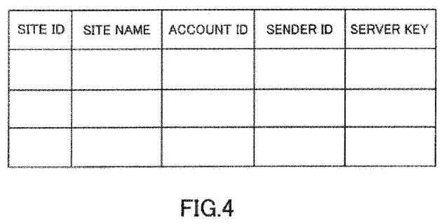

As illustrated in FIG. 4, in the site information management table, a site for managing a cryptographic key, in other words, information about a sender of a push notification is managed. For example, site information is associated with a site ID for uniquely identifying a site. The site information includes a site name, an account ID, a sender ID, and a server key. The account ID is an ID necessary for using advertisement distribution service. The account ID is issued by the management server 10. The sender ID is an ID for identifying the sender of a push notification. The sender ID is issued by the push-notification distribution server 40. The server key is an authentication key for using push notification service. The server key is issued by the push-notification distribution server 40. By holding the sender ID and the server key, the management server 10 can request a push notification from the push-notification distribution server 40 while acting as a proxy of the operating company of the music site. The sender ID and the server key are obtained in advance by applying for the use of push notification service by the operating company of the music site.

Information managed in the site information management table is registered by the operating company of the site. When the site information is registered by the operating company, the advertisement distribution management server 10 issues the first HTML tag and the second HTML tag. The first HTML tag and the second HTML tag that are issued by the advertisement distribution management server 10 are embedded in the HTML file of the top page of the music site by, for example, a person in charge in the operating company.

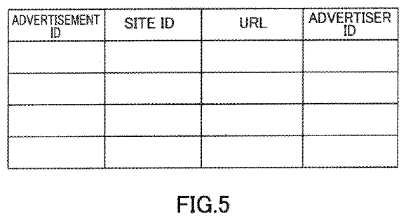

As illustrated in FIG. 5, in the advertisement information management table, advertisement information posted from an advertiser is managed. For example, advertisement information and an advertiser ID for identifying an advertiser are associated with an advertisement ID for uniquely identifying an advertisement. The advertisement information includes a site ID and a URL. The site ID corresponds to a site selected from a plurality of sites by the advertiser. The site selected by the advertiser serves as a sender of a push notification. The URL is the URL of an advertisement page that is displayed on the user terminal 50 in response to a click on the notification screen of a push notification. The advertisement information managed in the advertisement information management table is registered by the advertiser through an advertisement distribution site provided by an advertisement distributor. The advertiser selects a site where targets match the target customers of the advertisement page from a plurality of sites, thereby improving the effect of propaganda by the advertisement. Data displayed on the push notification screen, e.g., text data or image data may be associated with the advertisement ID.

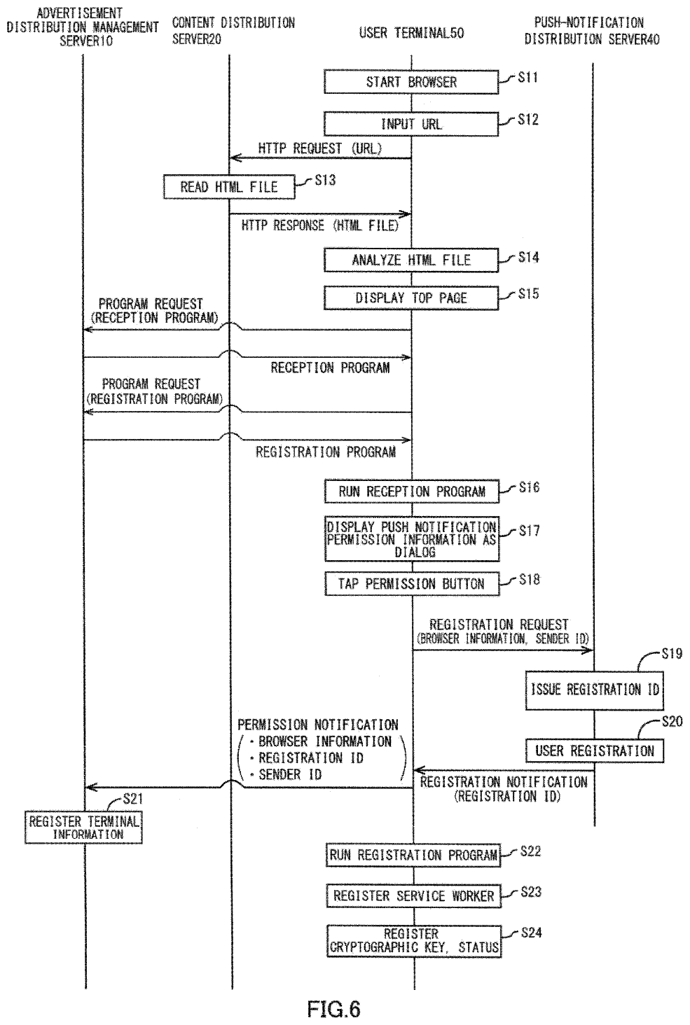

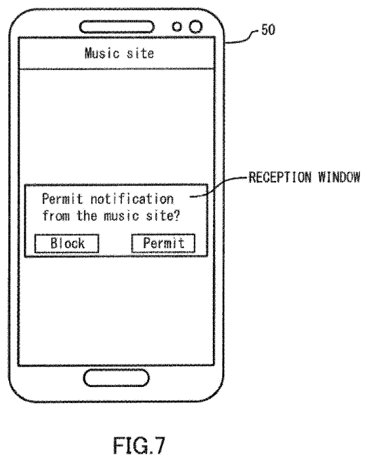

Referring to FIGS. 6 and 7, a flow will be described below, up to the registration of a service worker in the browser of the user terminal 50 for a user who is a visitor of the top page of the music site.

As illustrated in FIG. 6, the browser is started at the user terminal 50 in response to a user operation (step S11), the URL of the top page of the music site is inputted on a screen displayed by the browser (step S12). The browser of the user terminal 50 identifies the content distribution server 20 according to an IP address corresponding to the inputted URL, and requests an HTML file corresponding to the top page of the music site. The content distribution server 20 reads, from a storage unit, data on the HTML file requested from the browser of the user terminal 50 (step S13) and transmits the data to the user terminal 50. The browser of the user terminal 50 analyzes the received data on the HTML file from the content distribution server 20 (step S14) and displays the top page of the music site on the user terminal 50 (step S15). Moreover, the first HTML tag and the second HTML tag that are included in the HTML file are read, and then the reception program and the registration program are downloaded from the advertisement distribution management server 10.

The browser of the user terminal 50 runs the reception program, thereby performing the following processing (step S16). The browser displays a reception window (step S17). As illustrated in FIG. 7, the reception window includes a determination box that allows a user to determine whether to receive a push notification from the music site. In response to a click on “permit” button (permission button) on the reception window (step S18), the browser transmits, as a registration request, browser information and a sender ID specified on the top page of the music site or the reception program to the push-notification distribution server 40. The push-notification distribution server 40 issues a registration ID on the basis of the reception of the registration request (step S19), registers the issued registration ID associated with the sender ID and the browser information (step S20), and transmits the ID to the browser of the user terminal 50. The browser transmits the browser information, the sender ID, and the registration ID issued by the push-notification distribution server 40, to the advertisement distribution management server 10 as a permission notification. The advertisement distribution management server 10 registers the registration ID received from the user terminal 50, the sender ID, and the browser information in the terminal information management table such that the registration ID, the sender ID, and the browser information are associated with one another (step S21).

The browser of the user terminal 50 runs a service-worker registration program (step S22) and registers a service worker in the storage area of the browser (step S23). The service worker registers cryptographic key information in the storage area of the browser on the basis of a click on the permission button in step S18 and manages the status (step S24).

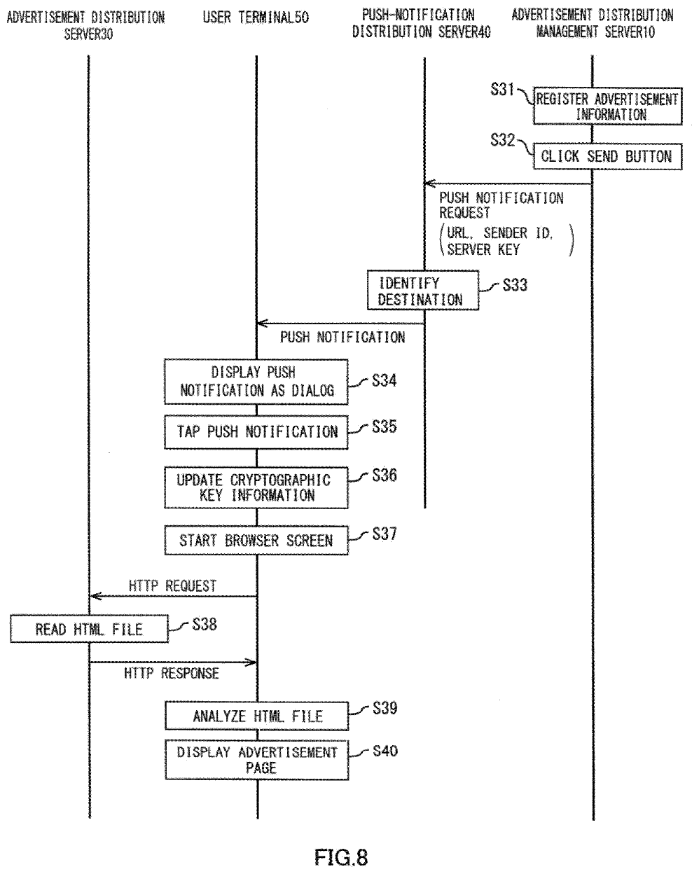

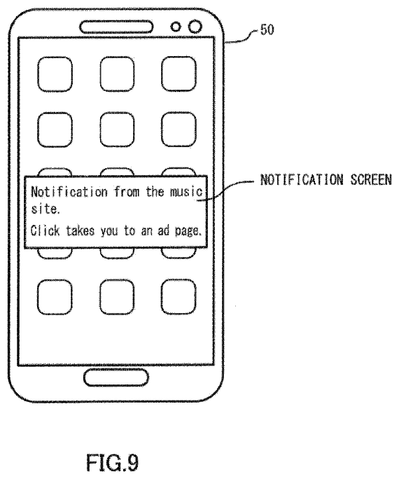

Referring to FIGS. 8 and 9, a flow will be described below, from the transmission of a push notification to the user terminal 50 to the update of the cryptographic key information registered in the user terminal 50.

As illustrated in FIG. 8, an advertiser accesses an advertisement distribution site, which is provided by the advertisement distribution management server 10, by using an information processor such as a personal computer or a smartphone, registers the URL of an advertisement page as advertisement information (step S31), and clicks a send button (step S32).

In response to a click on the send button of a push notification, the advertisement information is transmitted with the sender ID and a server key from the advertisement distribution management server 10 to the push-notification distribution server 40. The push-notification distribution server 40 performs authentication using the sender ID and the server key and identifies, on the basis of the sender ID, the user terminal 50 that has permitted the reception of a push notification from the music site (step S33). The push-notification distribution server 40 transmits the advertisement information to the browser of the identified user terminal 50 with a push notification. The browser of the user terminal 50 displays the notification screen of a push notification on the basis of the advertisement information (step S34). As illustrated in FIG. 9, the notification screen of a push notification is displayed as a dialog on the home screen. The notification screen includes information indicating that the sender of a push notification is the music site. The HTML of a push notification describes the URL of an advertisement page and a tag for linking to the advertisement page. The push notification may include a text that indicates that a click on the link extends the service period of the limited contents of the music site serving as a sender.

On the basis of a click on the link of a push notification (step S35), the service worker of the user terminal 50 updates the cryptographic key information (step S36). The processing in step S36 extends the validity period of a cryptographic key. The processing of step S36 may increase the number of uses or valid points instead of extending the validity period. The browser of the user terminal 50 starts the browser screen (step S37), identifies the advertisement distribution server 30 according to an IP address corresponding to the URL of the link, and requests an HTML file corresponding to the URL. The advertisement distribution server 30 reads, from the storage unit, data on the HTML file requested from the browser of the user terminal 50 (step S38) and transmits the data to the browser of the user terminal 50. The browser of the user terminal 50 analyzes the data on the HTML file, the data being received from the advertisement distribution server 30 (step S39), and then the browser displays the advertisement page (step S40).

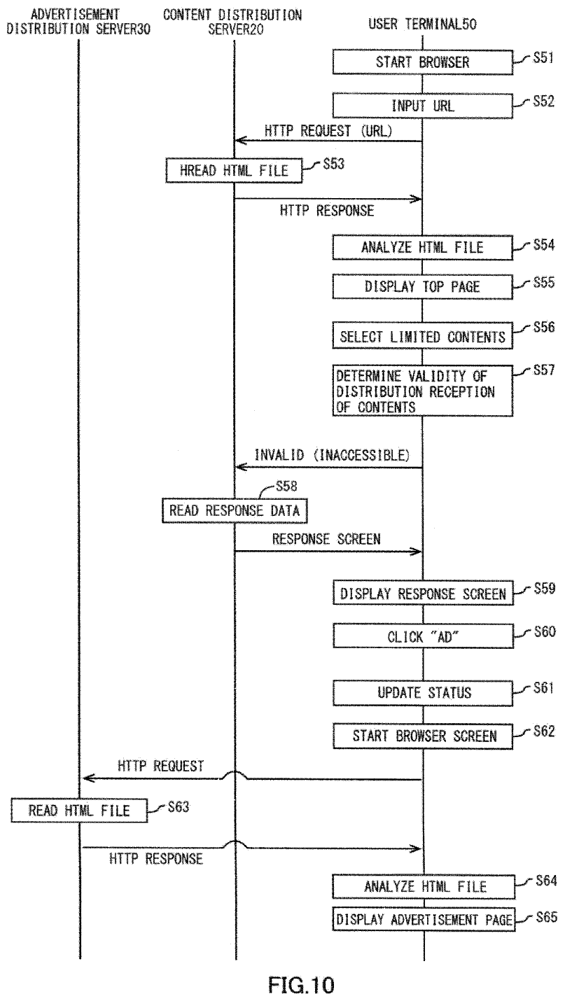

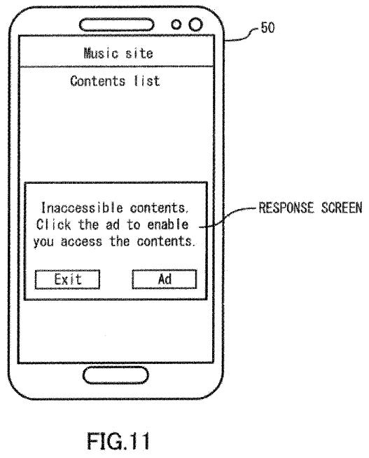

Referring to FIGS. 10 and 11, a flow of using limited contents through the user terminal 50 will be described below. Steps S51 to S55 in FIG. 10 correspond to steps S11 to S15 in FIG. 6 and thus a description thereof is omitted.

When limited contents are selected by a user operation in the music site (step S56), the service worker determines the validity of the distribution reception of the limited contents on the basis of key information (step S57). In other words, the service worker installed on the user terminal 50 determines the validity of the distribution reception of limited contents. The validity of the distribution reception of limited contents is determined in the user terminal 50.

When it is determined that the reception of content distribution is valid, the service worker permits the transmission of a content distribution request to the content distribution server 20. When it is determined that the reception of content distribution is not valid, the service worker does not permit the transmission of a content distribution request to the content distribution server.

As a matter of course, the determination result of the validity of the reception of content distribution may be transmitted from the user terminal 50 to the content distribution server 20, and then the content distribution server 20 may distribute contents to the user terminal 50 or may avoid distributing contents to the user terminal 50 according to the determination result.

Information about the determination result on the validity of the distribution reception of limited contents is transmitted to the content distribution server 20. Hereinafter it is assumed that the reception of the distribution of limited contents by a user is not valid.

When receiving information indicating that the reception of the distribution of limited contents is not valid, the first server 20 reads data on the HTML file of a response screen (step S58) and transmits the data to the user terminal 50. The browser of the user terminal 50 analyzes the data on the HTML file, the data being received from the content distribution server 20, and then the browser displays the response screen (step S59).

As illustrated in FIG. 11, the response screen includes a text that informs a user of the inaccessibility of limited contents and an “ad” button for providing the accessibility of limited contents again. The URL of the advertisement page is linked to the advertisement button. On the basis of a click on “ad” button of the response screen (step S60), the service worker of the user terminal 50 updates the cryptographic key information (step S61).

The browser of the user terminal 50 starts the browser screen (step S62), identifies the second server 30 by using an IP address corresponding to the URL of the link, and requests an HTML file corresponding to the URL. The second server 30 reads, from the storage device 17, data on the HTML file requested from the browser of the user terminal 50 (step S63) and transmits the data to the browser of the user terminal 50. The browser of the user terminal 50 analyzes the data on the HTML file, the data being received from the second server 30 (step S64), and then the browser displays the advertisement page (step S65). The processing of step S61 sets another validity period of the cryptographic key, allowing the user to use the limited contents again.

The advertisement distribution system according to the first embodiment has the following effects: The cryptographic key information registered in the user terminal 50 is updated on the basis of a click on the notification screen of a push notification. Thus, in order to continuously use limited contents, a user can be motivated to click the notification screen of a push notification and actively view the advertisement page of a link set on the notification screen. The user does not need to click the notification screen of a push notification at a specified timing The user may click the notification screen of a push notification at any timing, for example, in a free time. Thus, viewing the advertisement page of a link set on the notification screen of a push notification is less annoying than viewing videos interrupted by video advertisements.

Cryptographic key information registered in the user terminal 50 can be updated in response to a click on the “ad” button on the response screen as well as a click on the notification screen of a push notification. Thus, even if a user finds that limited contents are inaccessible due to expiration of validity period of the cryptographic key or the like when accessing the limited contents, the user can update the cryptographic key information by clicking the “ad” button on the response screen, thereby quickly restarting the use of the limited contents without waiting for a push notification.

The user terminal 50 is configured to manage cryptographic key information necessary for using limited contents, update the cryptographic key information, and determine whether the limited contents are accessible to the user on the basis of the cryptographic key information. Thus, a distributor of limited contents does not need to manage identification information such as terminal information about the user terminal 50, substantially eliminating the risk of leaking personal information. Since the management of cryptographic key information is not necessary, the risk of leaking a cryptographic key is small, thereby preventing an illegal access using a leaked cryptographic key. This can reduce the burden of managing various kinds of information by a company that accesses advertisement distribution service.

When a company accesses advertisement distribution service, the company only needs to embed an HTML tag, which is provided from an advertisement distributor, into an existing web page. Thus, the workload is small and the hurdle of accessing the service is significantly low.

### Second Embodiment

An advertisement distribution system according to a second embodiment is configured such that a management server 10 manages cryptographic key information, updates the cryptographic key information, and determines whether limited contents are accessible to a user on the basis of the cryptographic key information.

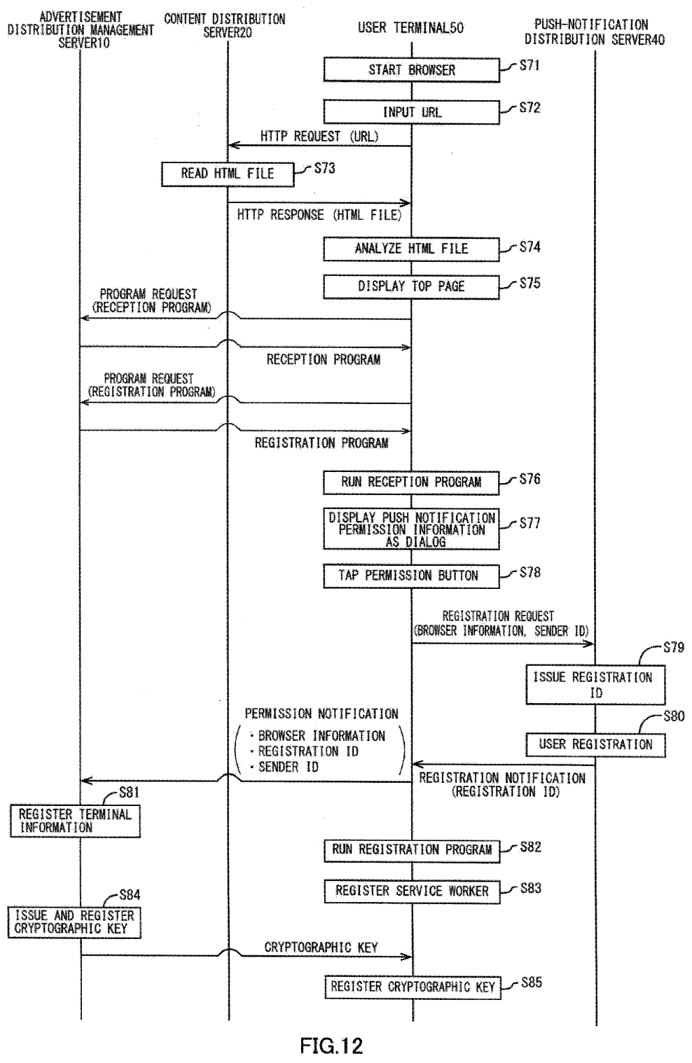

Referring to FIG. 12, a flow will be described below, up to the registration of cryptographic key information in the browser of a user terminal 50 for a user who is a visitor of the top page of a music site. Processing in steps S71 to S83 of FIG. 12 is identical to processing in steps S11 to S23 of FIG. 6, and thus a description thereof is omitted. In the second embodiment, a service worker is a different program from the service worker of the first embodiment.

As illustrated in FIG. 12, the advertisement distribution management server 10 registers a registration ID received from the user terminal 50, a sender ID, and browser information in a terminal information management table such that the registration ID, the sender ID, and the browser information are associated with one another (step S81). Furthermore, a cryptographic key is issued, and the issued cryptographic key is registered with information about the validity period in the terminal information management table while being associated with terminal information (step S84). The advertisement distribution management server 10 transmits the cryptographic key to the browser of the user terminal 50. The service worker registered in the browser of the user terminal 50 registers the cryptographic key in the storage area of the browser (step S85).

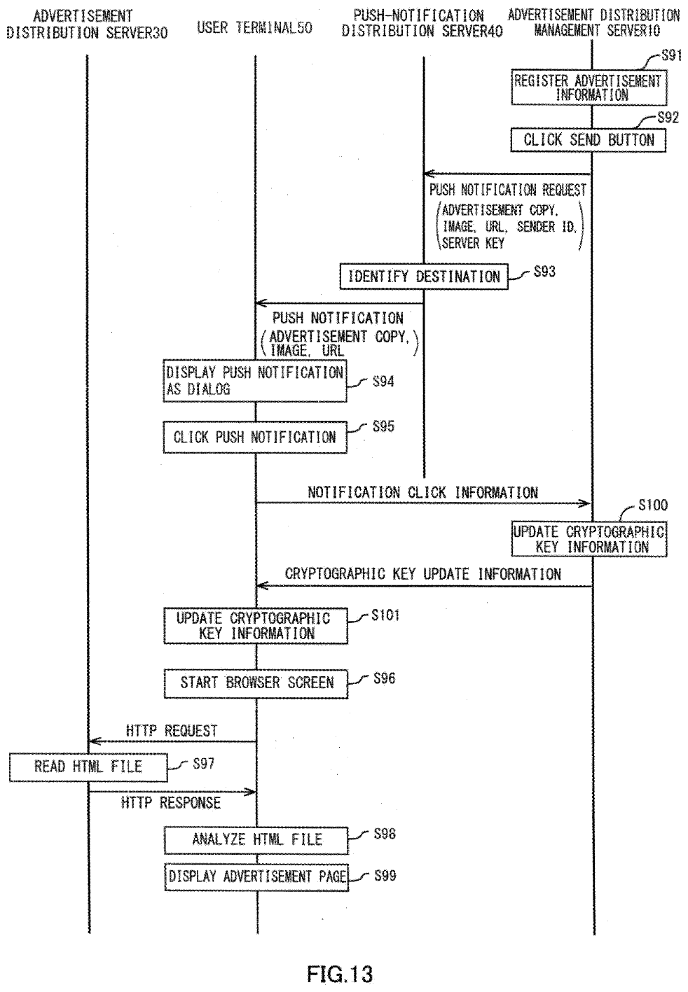

Referring to FIG. 13, a flow will be described below, from the transmission of a push notification to the user terminal 50 to the update of the cryptographic key registered in the user terminal 50. Processing in steps S91 to S99 of FIG. 13 is identical to processing in steps S31 to S35 and steps S37 to S40 of FIG. 8, and thus a description thereof is omitted.

As illustrated in FIG. 13, on the basis of a click on the notification screen of a push notification (step S95), the service worker installed on the user terminal 50 transmits click information, which indicates a click on the notification screen, with terminal information to the advertisement distribution management server 10. On the basis of the reception of the click information, the management server 10 updates cryptographic key information associated with the terminal information (step S100). The processing in step 5100 extends, for example, the validity period of a cryptographic key. The management server 10 transmits the updated cryptographic key information to the user terminal 50. The service worker of the user terminal 50 updates the cryptographic key information stored in the storage area of the browser (step 5101). The service worker of the user terminal 50 has the same function as the service worker registered for the user terminal 50 in the first embodiment.

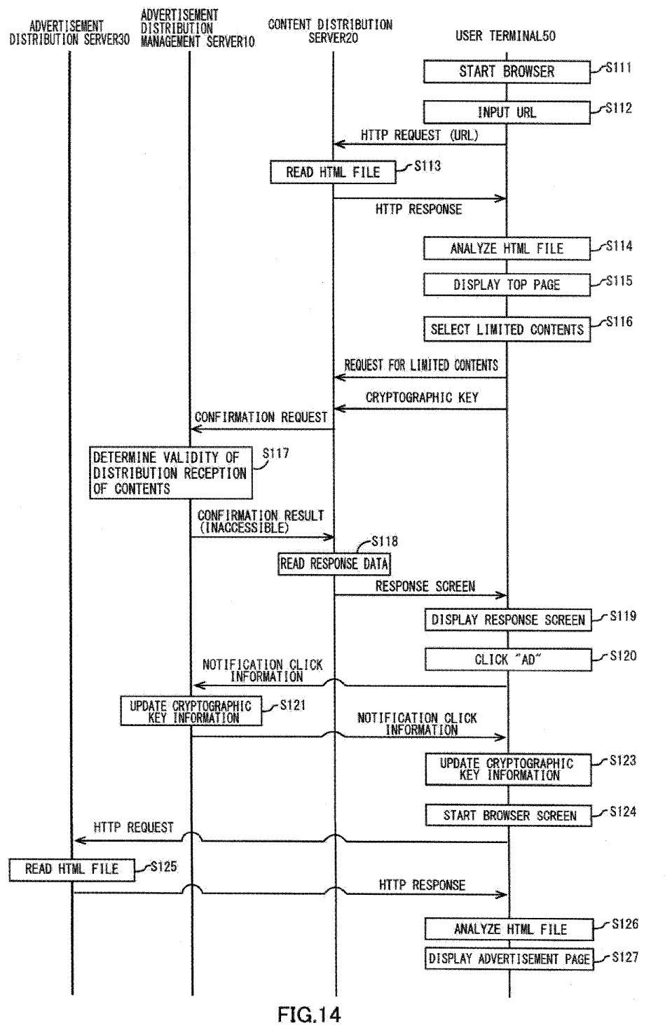

Referring to FIG. 14, a flow of using limited contents through the user terminal 50 will be described below. Steps S111 to S116 in FIG. 14 correspond to steps S11 to S15 in FIG. 6 and thus a description thereof is omitted.

As illustrated in FIG. 14, when limited contents are selected by a user operation in the music site (step S116), the browser requests the limited contents from a content distribution server 20. At this point, the service worker transmits a cryptographic key with terminal information to the content distribution server 20. The content distribution server 20 transfers, as a confirmation request, the cryptographic key and the terminal information that are received from the user terminal 50 to the advertisement distribution management server 10. The advertisement distribution management server 10 determines user accessibility with reference to cryptographic key information specified by the terminal information (step S117). In the case of access in a validity period with a matched cryptographic key, it is determined that user access is “permitted.” If no cryptographic key is matched or in the case of access before or after a validity period with a matched cryptographic key, it is determined that user access is “not permitted.” The advertisement distribution management server 10 returns information indicating whether user access is permitted, as a confirmation result to the content distribution server 20. Hereinafter it is assumed that user access is “not permitted.” When information indicating that user access is “permitted” is received as a confirmation result, the content distribution server 20 transmits data on limited contents to the user terminal 50. Thus, the limited contents are available to the user at the user terminal 50.

When receiving information indicating that user access is “not permitted,” the content distribution server 20 reads data on the HTML file of the response screen (step S118) and transmits the data to the user terminal 50. The browser of the user terminal 50 analyzes the data on the HTML file, the data being received from the content distribution server 20, and then the browser displays the response screen (step S119). On the basis of a click on the “ad” button on the response screen (step S120), the service worker of the user terminal 50 transmits click information, which indicates a click on the “ad” button, with terminal information to the advertisement distribution management server 10. The advertisement distribution management server 10 updates cryptographic key information registered in the terminal information management table (step S121) and transmits the updated cryptographic key information to the user terminal 50. The service worker installed on the user terminal 50 updates the cryptographic key information stored in the storage area of the browser (step S123). On the basis of a click on the “ad” button of the response screen (step S120), the browser of the user terminal 50 starts the browser screen (step S124), identifies the advertisement distribution server 30 according to an IP address corresponding to the URL of the link, and requests an HTML file corresponding to the URL. The advertisement distribution server 30 reads, from the storage unit, data on the HTML file requested from the browser of the user terminal 50 (step S125) and transmits the data to the browser of the user terminal 50. The browser of the user terminal 50 analyzes the data on the HTML file, the data being received from the advertisement distribution server 30 (step S126), and then the browser displays the advertisement page (step S127).

Although the advertisement distribution system according to the second embodiment needs to issue and manage a cryptographic key in the advertisement distribution management server 10, the cryptographic key can be updated on the basis of a click on a push notification as in the advertisement distribution system according to the first embodiment.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A non-transitory storage medium storing a program causing a computer to implement: the computer is a user terminal connected via a network to a first server that distributes contents and a second server that transmits a push notification,
generating key information that defines validity of distribution reception of contents from the first server in response to an access to a web page of a site where the first server distributes the contents;
storing the generated key information in a storage unit;
receiving a push notification from the second server;
detecting an operation for linking to an advertisement page from the push notification; and
updating the key information on a basis of the detection of the operation.

2. The non-transitory storage medium according to claim 1, wherein in the key information, a validity period in which the distribution of the contents is receivable is defined for the first server.

3. The non-transitory storage medium according to claim 1, wherein
the computer determines the validity of the distribution reception of the contents on a basis of the key information, and
the computer transmits information about the determined validity to the first server with a distribution request for the contents.

4. The non-transitory storage medium according to claim 1, wherein
the computer determines the validity of the distribution reception of the contents on a basis of the key information, and
the computer permits transmission of a distribution request for the contents to the first server when it is determined that the distribution reception of the contents is valid, whereas the computer avoid permitting the transmission of a distribution request for the contents to the first server when it is determined that the distribution reception of the contents is invalid.

5. The non-transitory storage medium according to claim 1, wherein in the key information, the number of uses or a service point of the contents is defined.

6. The non-transitory storage medium according to claim 1, wherein the program is installed on the computer from the web page.

7. An information processor comprising:
means connected via the network to a user terminal and a server that distributes contents;
means for storing key information that defines validity of distribution reception of the contents from the server, in association with terminal information that identifies the user terminal;
means for receiving, from the user terminal, operation information for linking to an advertisement page from a push notification transmitted to the user terminal; and
means for updating the key information in response to the reception of the operation information.

8. The information processor according to claim 7, further comprising:
means for receiving a confirmation request for the validity of the distribution reception of the contents from the server, along with the terminal information;
means for referring to the key information associated with the terminal information and determining the validity of the distribution reception of the contents in response to the reception of the confirmation request; and
means for transmitting information about the determined validity to the server.

9. A non-transitory storage medium storing a program causing a computer to implement:
storing, in a storage unit, key information that defines validity of distribution reception of contents from a server, in association with terminal information that identifies a user terminal;
receiving, from the user terminal, operation information for linking to an advertisement page from a push notification transmitted to the user terminal; and
updating the key information in response to the reception of the operation information,
wherein the computer is connected via the network to the user terminal and the server that distributes the contents.
